(19) United States
(12) Patent Application Publication
(10) Pub. No.: US 2001/0016565 A1
(43) Pub. Date: Aug. 23, 2001

(54) DETERGENT COMPOSITION

(75) Inventors: JEAN-FRANCOIS BODET, STROMBEEK-BEVER (BE); GARRY KENNETH EMBLETON, STROMBEEK-BEVER (BE); KAY EMMA FITZGIBBON, BRUSSELS (BE); SUCHAREETA PATIL, BRUSSELS (BE)

Correspondence Address: T DAVID REED, THE PROCTER & GAMBLE COMPANY, 5299 SPRING GROVE AVENUE, CINCINNATI, OH, 452171087

(73) Assignee: Jean-Francois Bodet

(21) Appl. No.: 09/403,511

(22) PCT Filed: Apr. 20, 1998
(86) PCT No.: PCT/IB98/00575

§ 371 Date: None

(30) Foreign Application Priority Data
Apr. 22, 1997 (BE) 97870053.2

(51) Int. Cl. C11D 1/00

(52) U.S. Cl. 510/220

(57) ABSTRACT

A liquid detergent composition, particularly suitable for washing dishes, comprises from 30% to 90%, by weight, of the total composition of water, and a surfactant mixture comprising i) a 100 % by weight linear, optionally alkoxylated, alkyl sulfate surfactant, and ii) a branched, optionally alkoxylated, alkyl sulfate surfactant, wherein the amount of branched alkyl sulfate surfactant is 10% to 60%, by weight, of the total alkyl sulfate surfactant, provided that if either or each of the linear and branched alkyl sulfate surfactants is alkoxylated, the molar weight average degree of alkoxylation is less than 1.4. The compositions have improved viscosity characteristics and good grease and/or suds performance, and are stable at low temperature.

### FIELD OF THE INVENTION

The present invention relates to aqueous liquid detergent compositions, especially for use in manual dishwashing operations.

### BACKGROUND OF THE INVENTION

Liquid dishwashing compositions having good grease removal properties are much desired by consumers, and therefore it is necessary that such compositions comprise effective surfactant systems. At the same time, however, consumers tend to associate good detergent performance with good sudsing, and therefore it is also necessary that dishwashing compositions are effective in this respect also.

Primary alkyl sulfates are anionic surfactant materials which are well known components of dishwashing compositions. Both linear and branched alkyl sulfates are known for this use, and convey different properties. The linear primary alkyl sulfates are superior in sudsing performance to the branched primary alkyl sulfates, but tend to be unstable at low temperatures, eg. below 5° C., typically −10° C. to 5° C. Branched primary alkyl sulfates have, therefore, been used to replace linear primary alkyl sulfates in dishwashing compositions to alter viscosity characteristics and improve stability, as described in our co-pending European Patent Application No. 97570005.2. However, the use of branched materials tends to have a deleterious effect on the detergency and sudsing performance of the dishwashing composition.

Accordingly, it is an object of the present invention to provide an alkyl sulfate based liquid detergent composition having improved viscosity characteristics and, at the same time, good detergency and sudsing performance. It is also an object of the present invention to provide a composition having good low temperature stability.

### SUMMARY OF THE INVENTION

According to the present invention, an aqueous liquid detergent composition comprises from 30% to 70%, by weight, of the total composition of water, and a surfactant mixture comprising

i) a 100% by weight linear, optionally alkoxylated, alkyl sulfate surfactant, and

ii) a branched, optionally alkoxylated, alkyl sulfate surfactant,

wherein the amount of branched alkyl sulfate surfactant is 10% to 60%, by weight, of the total alkyl sulfate surfactant, provided that if either or each of the linear and branched alkyl sulfate surfactants is alkoxylated the molar weight average degree of alkoxylation is less than 1.4.

The detergent compositions of the present invention possess benefits over compositions containing purely linear or purely branched primary alkyl sulfates, surprisingly even when the amount of branching in the composition is the same, or nearly the same, as that provided by a single branched material. In particular, the blend of linear and branched materials used in the present invention gives good detergency and sudsing, while at the same time improving the viscosity characteristics of the composition and rendering it more stable at lower temperatures.

The benefits observed tend to differ according to the type of composition formulated. For instance, when the composition is to be a “full strength” product (i.e. for immediate use) containing, typically, 25-40% by weight total active surfactant, lower amounts of organic solvent are required to achieve the target viscosity in the final product than if the composition contained only branched alkyl sulfate. This represents a significant cost-saving in terms of solvent usage alone. It is also advantageous from a safety standpoint as the final product will have an increased flashpoint, and this may make the building of new plants and transport of the product considerably cheaper. When the composition of the invention is formulated as a re-fill for dilution by the consumer, it maintains its viscosity on dilution over a wider range of dilution than compositions containing only branched alkyl sulfate material, and in general requires little or no pH control, or other methods of control, to achieve this.

When provided in dilute form, for instance typically containing 5 to 25% by weight total active surfactant, requiring thickening for use, for instance up to a target viscosity of 330 cps, less thickening agent may be needed. When the thickening agent is chloride, this has the extra advantage of reducing the corrosivity of the product.

The present invention further encompasses a method of making the above-described compositions; a method of washing dishes with the above-described compositions; and the use in dishwashing compositions of the defined linear and branched alkyl sulfates to improve the viscosity characteristics of such compositions without losing grease and suds performance, and to improve physical stability of such compositions at low temperature, eg. below 5° C.

### DESCRIPTION OF THE INVENTION

The compositions of the invention are aqueous liquid compositions. They typically comprise from 30% to 90% by weight of the total composition of water, preferably 40% to 60%. At water levels above 70% by weight, the problem of low temperature instability is generally not observed while, at levels below 30% stability may be impaired and formulation of a clear and stable product becomes increasingly difficult.

The compositions of the invention are liquid and so they typically have a viscosity of from 50 cps to 2000 cps, preferably 100 cps to 350 cps, measured with a Brookfield Viscometer, with a No. 18 spindle, at 20° C.

Suitable alkyl sulfates for use in the invention are of the formula R₁O(A)ₓSO₃M, wherein R₁ is an alkyl or alkenyl group having 10 to 18 carbon atoms, A is an alkoxy group, preferably ethoxy or propoxy, most preferably ethoxy, x is the average degree of alkoxylation and satisfies the inequality 0≦x<1.4, and M is an alkali metal, alkali earth metal, ammonium or alkanolammonium group, and is preferably sodium.

Preferably R₁ is a group having at least 12 carbon atoms, more preferably 12 to 16 carbon atoms, and most preferably 12 to 14 carbon atoms, as better detergency and sudsing is achieved with groups of this size. Preferably R₁ is an alkyl group.

A mixture of alkyl sulfates having different R₁ groups will typically be used, due to the nature of the commercially-available materials. In this case, the average number of carbon atoms in R₁ is preferably at least 12. Alkyl sulfates having R₁ groups with less than 12 carbon atoms may, therefore, be included, but if so they are preferably present in an amount of less than 25% by weight, more preferably less than 10%, by weight, based on the total alkyl sulfate present.

It is preferred that the distribution of alkyl groups in the mixture of linear and branched alkyl sulfate is different, and preferably broader than, the distribution of alkyl groups in both the linear and the branched alkyl sulfate alone. By a different distribution of alkyl groups we mean either that the mixture contains alkyl groups not present in one of the linear and branched alkyl sulfates, or that the weight proportion of the different alkyl groups in the mixture is different to that in both the linear and the branched alkyl sulfates.

As mentioned above, alkyl groups having 12 to 16 carbon atoms are preferred, and those having 12 to 14 carbon atoms most preferred. In these instances, preferably the amount of alkyl sulfate with alkyl groups having at least 14 carbon atoms is in the range 2 to 30%, by weight, based on the total alkyl sulfate present, more preferably 10 to 25%, by weight, and most preferably 10 to 20%, by weight. In addition, preferably some of that material comprises >C₁₄ alkyl sulfates, for instance C₁₆ alkyl sulfates, or higher alkyl sulfates, typically in an amount up to 15%, by weight, based on the total alkyl sulfate present, and more preferably 1 to 10%, by weight.

The use of alkyl alkoxylated sulfates is preferred over the non-alkoxylated sulfates due to their enhanced stability. As is apparent from the nature of x, the present invention allows for the use of different alkyl alkoxylated sulfates having different degrees of alkoxylation. In this case, the resulting average x value in the composition will be the weighted molar average x value of the individual x values of the different alkyl alkoxylated sulfates.

As described above, when alkoxylated, the molar weight average degree of alkoxylation, x, based both on linear and branched alkyl sulfate, must be less than 1.4, as the advantages associated with the compositions of the invention are not observed above this level of alkoxylation. Preferably, the molar weight average degree of alkoxylation is below 1.0, as this improves the performance of the composition both in terms of grease removal and sudsing, due to the corresponding increase in the effective molar amount of anionic surfactant per % by weight of the total composition. More preferably, the molar weight average degree of alkoxylation is in the range 0.4 to 0.8, and is most preferably about 0.6, or just above or just below this.

Suitable 100% linear alkyl (alkoxy) sulfate materials are derived from any of the natural alcohols, for instance coconut, tallow, palm kernel, and mixtures thereof. Coconut sulfate, optionally alkoxylated, is preferred.

Any branched alkyl sulfate, or mixture of branched sulfates, may be used. By branched material, it is meant that R₁ in the above formula is branched, with the position of branching, and the length of the branched group, being determined by the position of the CH₂—OH functional group in the parent alcohol. The branched group can include up to 5 carbon atoms, but typically contains 1 to 4 carbon atoms.

If a single branched material is used it is preferred that it contains different isomers, one of which may be linear, and is not 100 wt.% of a single branched isomer, such as the Guerbet type materials. If, however, a 100 wt.% single isomer branched material is used, preferably this is used on combination with another, different, branched sulfate isomer.

It is essential that the amount of branched alkyl sulfate is in the range 10 to 60%, by weight, of the total alkyl sulfate surfactant (branched plus linear) in the composition, and preferably 15 to 45%, by weight, is branched, and more preferably 15 to 30%, by weight, and most preferably 15 to 20%, by weight:.

The relative amounts of the 100 wt.% linear and the branched alkyl sulfates is unimportant, provided that the required degree of branching is obtained in the final product.

Alkyl sulfates are commercially available with a variety of chain lengths, degrees of alkoxylation and degrees of branching under the trade names Empicol® ESA 70 (AELS) or Empicol® ESB 70 (AE2S) by Albright & Wilson, with C12/14 carbon chain length distribution which are derived from natural alcohols and are 100% linear, Empimin KSL68/A—AELS and Empimin® KSN70/LA - AE3S by Albright & Wilson with C12/13 chain length distribution and about 60% branching, Dobanol® 2:3 ethoxylated sulfates from Shell with C12/13 chain length distribution and about 18% branching, sulfated Lial® 123 ethoxylates from Condea Augusta with C12/13 chain length distribution and about 60% branching and sulfated Isalchem® 123 alkoxylates with C12/13 chain length distribution and about 95% branching.

Also, suitable alkyl alkoxylated sulfates can be prepared by alkoxylating and sulfating the appropriate alcohols, as described in “Surfactants in Consumer Products” edited by J. Falbe and “Fatty oxo-alcohols: Relation between their alkyl chain structure and the performance of the derived AE, AS, AES” submitted to the 4th World Surfactants, Barcelona, 3-7 VI 1996 Congress by Condea Augusta. Commercial oxo-alcohols are a mixture of primary alcohols containing several isomers and homologues. Industrial processes allow one to separate these isomers hence resulting in alcohols with linear isomer content ranging from 5-10% to up to 95%. Examples of available alcohols for alkoxylation and sulfation are Lial® alcohols by Condea Augusta (60% branched), Isalchem® alcohols by Condea Augusta (95% branched), Dobanol alcohols by Shell (18% branched).

A preferred composition according to the present invention comprises a branched C12/13 ethoxylated alkyl sulfate, such as Dobanol®23 available from Shell, and a C12/14 linear ethoxylated alkyl sulfate, for instance as available from Huls, and more preferably further comprises a second branched ethoxylated alkyl sulfate, for instance Lial® 123 available from Condea Augusta, and the composition has an average degree of branching of about 18% by weight.

The composition herein can further comprise a variety of optional components as follows:

Magnesium ions:

The compositions of the invention can comprise from 0% to 2.0%, preferably 0.1% to 2%, most preferably from 0.3% to 2% by weight of the composition, of magnesium ions which may be added to the liquid detergent compositions of the invention for improved grease removal in soft water.

It is preferred that the magnesium ions are introduced by neutralization of the acid form of alkylethoxy surfactants with a magnesium oxide or magnesium hydroxide slurry in water. Normally, this method is limited by the amount of anionic surfactants in the composition. An alternative method is to use MgCl₂, MgSO₄ or other inorganic Mg salts. These materials are less desirable because they can cause corrosivity problems (chloride salts), decrease the solubility of the formulations, or cause formulatibility/stability problems in the compositions. It is desirable for these reasons to limit the addition of inorganic salts to less than 2%, preferably less than by weight, of the anionic inorganic counterion.

Solvent:

The compositions of the invention can comprise a solvent in an effective amount so as to reach the desired viscosity. Suitable solvents include low molecular weight alcohols such as C₁-C₁₀, preferably C₁-C₄ mono- and dihydric alcohols, preferably ethyl alcohol, isopropyl alcohol, propylene glycol and hexylene glycol, and mixtures thereof. Typically, the amount of solvent comprises from 2% to 10% by weight of the total composition, preferably 2% to 8%, most preferably 2% to 7%.

Hydrotrope:

The compositions of the invention can comprise a hydrotrope in an effective amount so that the compositions are appropriately soluble in water. By “appropriately soluble in water”, it is meant that the product dissolves quickly enough in water as dictated by both the washing habit and conditions of use. Products which do not dissolve quickly in water can lead to negatives in performance regarding grease cleaning, sudsing, ease of rinsing of product from dishes/glasses etc. or product remaining on dishes/glasses after washing. Inclusion of hydrotropes also serve to improve product stability and formulatibility as is well known in the literature and prior art.

Suitable hydrotropes include anionic-type hydrotropes, particularly sodium, potassium, and ammonium xylene sulfonate (preferred), sodium, potassium and ammonium toluene sulfonate, sodium potassium and ammonium cumene sulfonate (most preferred), and mixtures thereof, and related compounds (as disclosed in U.S. Pat. No. 3,915,903).

The compositions of the invention typically comprise from 0% to 15% by weight of the total composition of a hydrotrope, preferably from 0% to 10%, most preferably from 0% to 6%.

Preferably, the compositions herein are formulated as clear liquid compositions. By “clear” it is meant stable and transparent, in the absence of pearlescent materials or opacifiers or other materials that may be used to alter the aesthetic properties of the final product. In order to achieve clear compositions, the use of solvents and hydrotropes is well known to those familiar with the art of dishwashing formulations. The clear compositions are preferably packaged in transparent containers, which can typically be made out of plastic or glass.

Co-surfactants:

The compositions of the invention may also contain certain co-surfactants to aid in the foaming, detergency, and/or mildness. Included in this category are several anionic surfactants commonly used in liquid or gel dishwashing detergents. Examples of anionic co-surfactants that are useful in the present invention are the following classes:

(1) Alkyl benzene sulfonates in which the alkyl group contains from 9 to 15 carbon atoms, preferably 11 to 14 carbon atoms in straight chain or branched chain configuration. An especially preferred linear alkyl benzene sulfonate contains about 12 carbon atoms. U.S. Pat. Nos. 2,220,099 and 2,477,383 describe these surfactants in detail.

(2) Alkyl sulfates obtained by sulfating an alcohol having 8 to 22 carbon atoms, preferably 12 to 16 carbon atoms. The alkyl sulfates have the formula ROSO₃⁻M⁺ where R is the C₈₋₂₂ alkyl group and M is a mono- and/or divalent cation.

(3) Paraffin sulfonates having 8 to 22 carbon atoms, preferably 12 to 16 carbon atoms, in the alkyl moiety. These surfactants are commercially available as Hostapur SAS from Hoechst Celanese.

(4) Olefin sulfonates having 8 to 22 carbon atoms, preferably 12 to 16 carbon atoms. U.S. Pat. No. 3,332,880 contains a description of suitable olefin sulfonates.

(5) Alkyl glyceryl ether sulfonates having 8 to 22 carbon atoms, preferably 12 to 16 carbon atoms, in the alkyl moiety.

(6) Fatty acid ester sulfonates of the formula:

R₁—CH(SO₃⁻M⁺)CO₂R₂

wherein R₁ is straight or branched alkyl from about C₈ to C₁₈, preferably C₁₂ to C₁₆, and R₂ is straight or branched alkyl from about C₁ to C₆, preferably primarily C₁, and M⁺ represents a mono- or divalent cation.

(7) Secondary alcohol sulfates having 6 to 18, preferably 8 to 16 carbon atoms.

Other suitable co-surfactants herein are

(8) Fatty acid amide surfactants having the formula:

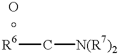

wherein R⁶ is an alkyl group containing from 7 to 21, preferably from 9 to 17, carbon atoms and each R⁷ is selected from the group consisting of hydrogen, C₁-C₄ alkyl, C₁-C₄ hydroxyalkyl, and —(C₂H₄O)ₓH where x varies from 1 to about 3.

(9) Polyhydroxy fatty acid amide surfactant of the structural formula:

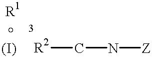

wherein R¹ is H, C₁-C₄ hydrocarbyl, 2-hydroxy ethyl, 2-hydroxy propyl, or a mixture thereof, preferably C₁-C₄ alkyl, more preferably C₁ or C₂ alkyl, most preferably C₁ alkyl (i.e., methyl); and R² is a C₅-C₃₁ hydrocarbyl, preferably straight chain C₇-C₁₉ alkyl or alkenyl, more preferably straight chain C₉-C₁₇ alkyl or alkenyl, most preferably straight chain C₁₁-C₁₇ alkyl or alkenyl, or mixtures thereof; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z preferably will be derived from a reducing sugar in a reductive amination reaction; more preferably Z is a glycityl. Suitable reducing sugars include glucose, fructose, maltose, lactose, galactose, mannose, and xylose. Z preferably will be selected from the group consisting of —CH₂—(CHOH)ₙ—CH₂OH, —CH(CH₂OH)—(CHOH)ₙ₋₁—CH₂OH, —CH₂—(CHOH)₂(CHOR′)(CHOH)—CH₂OH, where n is an integer from 3 to 5, inclusive, and R′ is H or a cyclic or aliphatic monosaccharide, and alkoxylated derivatives thereof. Most preferred are glycityls wherein n is 4, particularly —CH₂—(CHOH)₄—CH₂OH.

In formula (I), R¹ can be, for example, N-methyl, N-ethyl, N-propyl, N-isopropyl, N-butyl, N-2-hydroxy ethyl, or N-2-hydroxy propyl.

R²—CO—N< can be, for example, cocamide, stearamide, oleamide, lauramide, myristamide, capricamide, palmitamide, tallowamide, etc.

Z can be 1-deoxyglucityl, 2-deoxyfructityl, 1-deoxymaltityl, 1-deoxylactityl, 1-deoxygalactityl, 1-deoxymannityl, 1-deoxymaltotriotityl, etc.

(10) Betaine detergent surfactants having the general formula:

R—N⁽⁺⁾(R¹)₂—R²COO⁽⁻⁾

wherein R is a hydrophobic group selected from the group consisting of alkyl groups containing from 10 to 22 carbon atoms, preferably from 12 to 18 carbon atoms, alkyl aryl and aryl alkyl groups containing a similar number of carbon atoms with a benzene ring being treated as equivalent to about 2 carbon atoms, and similar structures interrupted by amide or ether linkages; each R¹ is an alkyl group containing from 1 to about 3 carbon atoms; and R² is an alkylene group containing from 1 to about 6 carbon atoms.

(11) Ethylene oxide condensates, which can be broadly defined as compounds produced by the condensation of ethylene oxide groups (hydrophilic in nature) with an organic hydrophobic compound, which can be aliphatic or alkyl aromatic in nature. The length of the hydrophilic or polyoxyalkylene radical which is condensed with any particular hydrophobic group can be readily adjusted to yield a water-soluble compound having the desired balance between hydrophilic and hydrophobic elements.

Examples of such ethylene oxide condensates suitable as suds stabilizers are the condensation products of aliphatic alcohols with ethylene oxide. The alkyl chain of the aliphatic alcohol can either be straight or branched and generally contains from about 8 to about 18, preferably from about 8 to about 14, carbon atoms for best performance as suds stabilizers, the ethylene oxide being present in amounts of from about 8 moles to about 30, preferably from about 8 to about 14 moles of ethylene oxide per mole of alcohol.

(12) Cationic quaternary ammonium surfactants of the formula:

[R¹(OR²)_{y}][R³(OR²)_{y}]₂R⁴N⁺X⁻

or amine surfactants of the formula:

[R¹(OR²)_{y}][R³(O²)_{y}]R⁴N

wherein R¹ is an alkyl or alkyl benzyl group having from about 6 to about 16 carbon atoms in the alkyl chain; each R is selected from the group consisting of —CH₂CH₂—, —CH₂CH(CH₃) —, —CH₂CH(CH₂OH)—, —CH₂CH₂CH₂—, and mixtures thereof; each R³ is selected from the group consisting of C₁-C₄ alkyl, C₁-C₄ hydroxyalkyl, benzyl, and hydrogen when y is not 0; R⁴ is the same as R³ or is an alkyl chain wherein the total number of carbon atoms of R¹ plus R⁴ is from about 8 to about 16, each y is from about 0 to about 10, and the sum of the y values is from about 0 to about 15; and X is any compatible anion.

When the composition comprises surfactant material additional to the alkyl sulfate surfactants, the latter (linear and branched) may comprise up to 90% by weight, preferably 40 to 80% by weight, of the total surfactant in the composition.

In addition to the optional co-surfactants described hereinbefore, the compositions can contain other optional components suitable for use in liquid dishwashing compositions such as perfume, dyes, opacifiers, enzymes, builders and chelants and pH buffering means so that the compositions herein generally have a pH of from 5 to 11, preferably 6.5 to 8.5, most preferably 7 to 8.

The compositions of the present invention can be prepared by conventional techniques according to the ultimate use of the composition. In general, they are prepared by blending together the linear and the branched alkyl sulfate in the necessary proportions to achieve the desired degree of branching, and then blending with water and with any other components required in the final composition.

In use, soiled dishes are contacted with an effective amount, typically from about 0.5 ml to about 20 ml (per 25 dishes being treated), preferably from about 3 ml to about 10 ml, of the detergent composition of the present invention. The actual amount of liquid detergent composition used will be based on the judgement of user, and will typically depend upon factors such as the particular product formulation of the composition, including the concentration of active ingredients in the composition, the number of soiled dishes to be cleaned, the degree of soiling on the dishes, and the like.

The particular product formulation, in turn, will depend upon a number of factors, such as the intended market (i.e., U.S., Europe, Japan, etc.) for the composition product.

Generally, from about 0.01 ml to about 150 ml, preferably from about 3 ml to about 40 ml of a liquid detergent composition of the invention is combined with from about 2000 ml to about 20000 ml, more typically from about 5000 ml to about 15000 ml of water in a sink having a volumetric capacity in the range of from about 1000 ml to about 20000 ml, more typically from about 5000 ml to about 15000 ml. The soiled dishes are immersed in the sink containing the diluted compositions then obtained, where they are cleaned by contacting the soiled surface of the dish with a cloth, sponge, or similar article. The cloth, sponge, or similar article may be immersed in the detergent composition and water mixture prior to being contacted with the dish surface, and is typically contacted with the dish surface for, typically, about 1 to about 10 seconds, although the actual time will vary with each application and user. The contacting of cloth, sponge, or similar article to the dish surface is preferably accompanied by a concurrent scrubbing of the dish surface.

Another method of use will comprise immersing the soiled dishes into a water bath without any liquid dishwashing detergent. A device for absorbing liquid dishwashing detergent, such as Et sponge, is placed directly into a separate quantity of undiluted liquid dishwashing composition for, typically, about 1 to about 5 seconds. The absorbing device, and consequently the undiluted liquid dishwashing composition, is then contacted individually to the surface of each of the soiled dishes to remove said soiling. The absorbing device is typically contacted with each dish surface for about 1 to about 10 seconds, although the actual time of application will be dependent upon factors such as the degree of soiling of the dish. The contacting of the absorbing device to the dish surface is preferably accompanied by concurrent scrubbing.

The present invention is now further illustrated by the following Examples, in which all components are given in % by weight of the total composition.

### EXAMPLE 1

Compositions A and B were formulated by mixing together the components shown below in Table 1, and then adding ethanol to achieve a viscosity of 340 cps. Less ethanol was required to achieve the desired viscosity in the composition comprising a mixture of linear and branched alkyl sulfate according to the present invention than in a composition comprising only branched alkyl sulfate, despite the fact that the total branching in each composition was approximately the same.

TABLE 1

| COMPONENT | A | B |
|---|---|---|
| Alkyl Ethoxy | 25 | 25 |
| (x = 0.6) Sulfate | Dobanol ® 23 | 50% Dobanol ® 23 NaAE0.6S |
| | NaAE0.6S | 35% Husl ® C12/14 NaAE0.6S |
| | Total branching: | 15% Lial ® 123 NaAE0.6S |
| | 18% | Total branching: approx. 18% |
| Glucose Amide | 1.5 | 1.5 |
| 1:1 Betaine: | 3.5 | 3.5 |
| Amine Oxide | | |
| C10E8 | 4.5 | 4.5 |
| ethoxylated | | |
| alcohol based on | | |
| Dobanol ® 91 | | |
| Mg | 0.5 | 0.5 |
| Ethanol | 8.0 | 6.5 |
| Water | up to 100% | up to 100% |
| pH (10% sin.) | 8.0 | 6.5 |
| Viscosity/cps | 340 | 340 |

### EXAMPLE 2

Compositions C and D shown below in Table 2 were formulated as a refill product (containing about 36% by weight active), by mixing the components shown below and were subsequently diluted three times so as to be suitable for use. The composition comprising the blend of linear and branched alkyl sulfate according to the present invention maintained its viscosity on dilution, whereas the composition comprising only branched alkyl sulfate suffered a substantial decrease in viscosity.

TABLE 2

| COMPONENT | C | D |
|---|---|---|
| Alkyl Ethoxy | 25 | 25 |
| (x = 0.6) Sulfate | Dobanol ® 23 | 50% Dobanol ® 23 NaAE0.6S |
| | NaAE0.6S Total | 35% Huls ® C12/14 NaAE0.6S |
| | branching: 18% | 15% Lial ® 123 NaAE0.6S |
| | | Total branching: approx. 18% |
| Glucose Amide | 1.5 | 1.5 |
| 1:1 Betaine: | 3.5 | 3.5 |
| Amine Oxide | | |
| C10E8 | 4.5 | 4.5 |
| ethoxylated | | |
| alcohol based | | |
| on Dobanol ® 91 | | |
| Mg | 0.5 | 0.5 |
| Ethanol | 6.0 | 6.0 |
| Cl⁻ | 0.2 | 0.2 |
| Water | up to 100% | up to 100% |
| pH (10% sin.) | 8 | 8 |
| Viscosity/cps | 420 | 330 |
| of Refill | | |
| Viscosity/cps | 150 | 330 |
| after dilution 3x | | |

### EXAMPLE 3

Compositions E and F were formulated by mixing the components shown below in Table 3, and their low temperature stability tested by maintaining at 4° C. and at 0° C. for 3 weeks.

Both compositions were clear at a temperature of 4° C., but at a temperature of 0° C. a precipitate of white crystals formed in Composition E, containing only the branched alkyl sulfate, but not in Composition F, containing the blend of linear and branched alkyl sulfate according to the present invention, which remained clear.

TABLE 3

| COMPONENT | E | F |
|---|---|---|
| Alkyl Ethoxy | 32.6 | 22.6 Huls ® C12/14 |
| (x = 0.6) Sulfate | Dobanol ® 23 | NaAE0.6S |
| | NaAE0.6S | 10.0 Lial ® 123 NaAE0.6S |
| | Total branching: | Total branching: approx. |
| | 18% | 18% |
| Glucose Amide | 1.5 | 1.5 |
| 1:1 Betaine: | 3.5 | 3.5 |
| Amine Oxide | | |
| C10E8 | 5 | 5 |
| ethoxylated | | |
| alcohol based on | | |
| Dobanol ® 91 | | |
| Mg | 0.5 | 0.5 |
| Ethanol | 6 | 6 |
| Water | up to 100% | up to 100% |
| pH (10% sin.) | 8.0 | 8.0 |
| Viscosity/cps | 330 | 330 |
| *Stability at 4° | PASS | PASS |
| C./3 weeks | | |
| *Stability at 4° | FAIL | PASS |
| C./3 weeks | | |

*PASS indicates that product shows no visible change from clear product.
*FAIL indicates that product cloudy.

What is claimed is:

1. An aqueous liquid detergent composition comprising from 30% to 90%, by weight, of the total composition of water, and a surfactant mixture comprising
i) a 100% by weight linear, optionally alkoxylated, alkyl sulfate surfactant, and
ii) a branched, optionally alkoxylated, alkyl sulfate surfactant,
wherein the amount of branched alkyl sulfate surfactant is 10% to 60% by weight of the total alkyl sulfate surfactant, provided that if either or each of the linear and branched alkyl sulfate surfactants is alkoxylated the molar weight average degree of alkoxylation is less than 1.4.

2. A composition according to claim 1, provided that if linear alkyl sulfate surfactant is coconut alcohol sulfate the alkyl group of the branched alkyl sulfate surfactant contains on average at least 12 carbon atoms.

3. A composition according to claim 1 or claim 2, wherein the branched alkyl sulfate surfactant comprises a mixture of isomers.

4. A composition according to any preceding claim, wherein the distribution of alkyl groups in the surfactant mixture is different to the distribution of alkyl groups in both the linear and the branched alkyl sulfate alone.

5. A composition according to claim 4, wherein the distribution of alkyl groups in the surfactant mixture is broader than the distribution of alkyl groups in both the linear and the branched alkyl sulfate alone.

6. A composition according to any preceding claim, which is clear.

7. A composition according to any preceding claim, wherein the amount of branched alkyl sulfate surfactant is 10% to 45%, preferably 15% to 30%, more preferably 15% to 20%, by weight.

8. A composition according to any preceding claim, wherein one or both of the linear and branched alkyl sulfate surfactants is/are alkoxylated, preferably ethoxylated or propoxylated, more preferably ethoxylated.

9. A composition according to claim 8, wherein the molar weight average degree of alkoxylation is less than 1, preferably 0.4-0.8, and more preferably about 0.6.

10. A composition according to any preceding claim, wherein both the linear and the branched alkyl sulfate surfactants contain alkyl groups having, on average, at least 12 carbon atoms.

11. A composition according to claim 10, wherein both the linear and branched alkyl sulfate surfactants contain alkyl groups having, on average, 12 to 16 carbon atoms, preferably 12 to 14 carbon atoms.

12. A composition according to claim 10 or claim 11, wherein the amount of alkyl sulfate with alkyl groups having at least 14 carbon atoms is 10 to 30%, by weight, based on the total alkyl sulfate, preferably 10 to 25%, by weight, and more preferably 10 to 20%, by weight.

13. A composition according to claim 12, wherein the amount of alkyl sulfate with alkyl groups having more than 14 carbon atoms is up to 15%, by weight, based on the total amount of alkyl sulfate, and preferably 1 to 10%, by weight.

14. A composition according to any preceding claim, which comprises at least two different branched alkyl sulfates.

15. A composition according to any preceding claim, which further comprises an organic solvent in an amount of 2 to 10% by weight, preferably 2 to 8% by weight, more preferably 2 to 7% by weight, of the total composition.

16. A composition according to any preceding claim, which further comprises additional surfactant material, wherein the linear and branched alkyl sulfate surfactants together comprise up to 90% by weight, preferably 40 to 80% by weight, of the total surfactant in the composition.

17. An aqueous liquid detergent composition is obtainable by mixing with water
i) a 100% by weight linear, optionally alkoxylated, alkyl sulfate surfactant, and
ii) a branched, optionally alkoxylated, alkyl sulfate surfactant,
in proportions such that the amount of water in the composition is 30% to 70%, by weight, and the amount of branched alkyl sulfate surfactant is 10% to 60%, by weight, of the total alkyl sulfate surfactant, provided that if either or each of the linear and branched alkyl sulfate surfactants is alkoxylated the molar weight average degree of alkoxylation is less than 1.4.

18. A composition according to claim 17, having the features of any of claims 1 to 16.

19. A method of making an aqueous liquid detergent composition comprising mixing with water
i) a 100% by weight linear, optionally alkoxylated, alkyl sulfate surfactant, and
ii) a branched, optionally alkoxylated, alkyl sulfate surfactant,
in proportions such that the amount of water in the composition is 30% to 70%, by weight, and the amount of branched alkyl sulfate surfactant is 10% to 60%, by weight, of the total alkyl sulfate surfactant, provided that if either or each of the linear and branched alkyl sulfate surfactants is alkoxylated the molar weight average degree of alkoxylation is less than 1.4.

20. A method of washing dishes with a composition according to any preceding claim, wherein 0.01 ml to 150 ml of the composition is diluted in 2000 ml to 20,000 ml water to form a diluted composition, and the dishes are immersed in the diluted composition and cleaned by contacting the dish with a cloth, a sponge or a similar article.

21. A method of washing dishes, wherein the dishes are immersed in a water bath, and an effective amount of a composition according to any of claims 1 to 18 is absorbed onto a device, and the device contacts the dishes to clean the dishes.

22. Use of a composition according to any of claims 1 to 18 as a dishwashing composition.

23. Use of a linear and a branched alkyl sulfate surfactant as defined in any of claims 1 to 18, in a composition comprising from 30% to 90% by weight of water, to improve the physical stability of said composition at low temperatures, eg. less than 5° C.

24. Use of a linear and a branched alkyl sulfate surfactant as defined in any of claims 1 to 18, in a composition comprising from 30% to 90% by weight of water, to improve the viscosity characteristics of said composition without reducing grease and/or suds performance.
